(19) United States
(12) Patent Application Publication
(10) Pub. No.: US 2023/0196679 A1
(43) Pub. Date: Jun. 22, 2023

(54) DEVICE AND METHOD FOR ACQUIRING IMAGES OF A PAIR OF SPECTACLES

(71) Applicant: ACEP TRYLIVE, PARIS (FR)

(72) Inventors: Pascal MOBUCHON, PARIS (FR); Jean-Philippe SAYAG, PARIS (FR)

(73) Assignee: ACEP TRYLIVE, PARIS (FR)

(21) Appl. No.: 18/007,544

(22) PCT Filed: Jun. 8, 2021
(86) PCT No.: PCT/EP2021/065338

§ 371 Date: Dec. 1, 2022

(30) Foreign Application Priority Data
Jun. 12, 2020 (FR) 2006159

(51) Int. Cl. G06T 19/00; G02C 13/00; G06Q 30/0601

(52) U.S. Cl. CPC G06T 19/00; G02C 13/003; G06Q 30/0603

(57) ABSTRACT

A device for acquiring images of a pair of spectacles, including a flat surface defined by an outline having a known shape and dimensions, the flat surface having at least, on the periphery thereof: —a straightening, —a size reference, and in the centre: —an acquisition area having a homogenous, non-reflective colour, the acquisition area including at least two openings intended to support the legs of the pair, and at least one position marker representing the pupils of a wearer, so as to facilitate the height positioning of the spectacle lenses in the acquisition area.

### FIELD

The present invention relates to the field of augmented reality simulation for optics and more particularly, the field of virtual fitting of pairs of spectacles.

### BACKGROUND

In the field of virtual fitting, it is known to use augmented reality to allow customers to remotely try on several pairs of spectacles previously modelled in 3D.

However, to make this type of fitting possible, 3D modelling work is necessary beforehand for each pair of spectacles. There are different modelling techniques: manually, by modifying CAD models, by image acquisition, by 3D scanning etc. . . . but the use of these techniques generally requires the use of many resources (tools, time . . . ). For example, in the case of 3D modelling by image acquisition, it is necessary, on the one hand, to capture images of pairs of spectacles under specific conditions (luminosity, positioning of the pair, etc.), under several angles (image of the pair of spectacles from the front, images of the legs), and on the other hand, the processing of these images by complex modelling tools requiring the intervention of people qualified in the field.

Regarding the image capture phase, several portable and low-cost devices allowing the capture of images of objects already exist (portable photo booth for example). Although this type of device is known for its ease of use, it is not adapted for a pair of spectacle-type product (no precise positioning possible . . . ).

Regarding the image processing phase, the need for complex modelling tools and the need for the intervention of people qualified in the field lead to significant costs for optician/eyewear professionals.

Moreover, the 3D modelling of a pair of spectacles being a process requiring a considerable amount of time, there is a significant time lag between the arrival of new models of pairs of spectacles in store and their availability for their virtual fitting.

Also known are devices or methods such as those described in the American patent applications US2014/043332, US2016/327814 and US2015/055085. However, these devices or methods are not satisfactory.

### SUMMARY

The object of the present invention is therefore to overcome the aforementioned disadvantages and to propose a device and a method for acquiring images of pairs of spectacles, very low cost, which is simple and quick to use, allowing the acquisition of an image that can be used for an augmented reality fitting by a person who is not qualified in the field.

In accordance with the invention, provision is therefore made of a device for acquiring images of a pair of spectacles comprising a flat surface defined by an outline having a known shape and dimensions, said flat surface being remarkable in that it comprises at least, on the periphery thereof:
a straightening means,
a size reference,

in the centre:
an acquisition area having a homogenous, non-reflective colour, said acquisition area comprising at least two openings intended to support the legs of said pair, and at least one position marker representing the pupils of a wearer, so as to facilitate the height positioning of the spectacle lenses in said acquisition area.

A “straightening means” is a means used to obtain a perfectly front image of an object, there are two types, those used upstream of the image capture: support for positioning the image acquisition apparatus for example, those used downstream of the image capture: marker used to process the image and remove perspective effects.

A “size reference”, is a means having a known size allowing to find the size scale of the objects of an image.

A “wearer” is an individual wearing the pair of spectacles on his face.

Preferably, the flat surface has an outline of rectangular shape and has a colorimetric pattern.

Advantageously, the straightening means and the size reference are a black frame marking said outline of known dimensions.

Preferably, the colorimetric target is positioned between the black frame and the acquisition area.

Preferably, the openings include colour adjustment means identical to that of the acquisition area, allowing said openings to adapt to different types of spectacle legs.

An “adjustment means” refers to all the means used to limit the perimeter of an opening to the only space sufficient for the passage of a leg of the pair of spectacles.

Even more preferably, the adjustment means include at least two U-shaped covers, the width of the opening of which can vary according to the width of the legs of the spectacles, a rectangular-shaped cover and are intended to be disposed at the front of the openings in order to limit their surfaces.

Advantageously, the acquisition area includes a coded identification means allowing information concerning said device to be obtained.

The invention also relates to a method for acquiring images of a pair of spectacles using a device as described above, remarkable in that it includes at least the following steps:

a) Phase of Identification on a professional terminal:

a1) Display on an output peripheral of the professional terminal of an acquisition web page,

a2) Identification of the professional,

b) Acquisition Phase:

b1) Placement of a pair of spectacles on the acquisition area of a device (1),

b2) Capture of an image of the flat surface of a device (1) supporting the pair of spectacles using an image acquisition peripheral of a professional terminal,

b3) Acquisition of the coded identification means,

c) Image processing phase,

c1) Extraction of the rack of the pair of spectacles,

c2) Sending of a clipped image of the pair of spectacles and the features of the pair of spectacles to a virtual fitting server,

c3) Generation by the server of a 3D model of spectacles from the clipped image,

c4) Generation of a virtual fitting web page by the professional terminal,

d) Fitting phase:

d1) Sending of the virtual fitting web page to a customer terminal,

d2) Capture of an image of the customer's face using an image acquisition peripheral of the customer terminal or loading of an image of the customer's face from a photo gallery,

d3) Inlay of the 3D model of spectacles on the image of the customer's face to form a fitting image,

A “coded identification means” is a code or a visual means specific to the pair of spectacles. (QR code for example)

A “clipped image of a pair of spectacles” is an image of the pair of spectacles from which the background of the image is completely removed, only the pair of spectacle part is kept.

Preferably, after step a2, there is a step a3: Search for the 3D model of the pair of spectacles in a catalogue present on the server, and:
if the pair of spectacles is not present in the catalogue: after step c3, there is a step c3′: Saving the 3D model of the pair of spectacles in the catalogue on the server,
if the pair of spectacles is present in the catalogue: the image acquisition and processing phases are not carried out and the fitting phase is carried out from the 3D model of spectacles in the catalogue,

Even more preferably, step c1 comprises the following sub-steps:

c11) Straightening of the image of the flat surface of the device (1) supporting the pair of spectacles,

c111) Detection of the straightening means,

c112) Perspective correction,

c113) Extraction of the area of the image containing the pair of spectacles,

c12) Clipping of the rack of the pair of spectacles,

c121) Removal of the coloured background,

c122) Normalisation of the resolution.

### BRIEF DESCRIPTION OF THE FIGURES

Other advantages and features are described below.

FIG. 1 is a front view of the device according to the invention.

FIG. 2 is an overview of a device according to the invention and an image acquisition apparatus.

FIG. 3 is a flowchart of the method in accordance with the invention.

FIG. 4 is a schematic representation of an adjustment means of the 2-cover system type with 2 degrees of freedom for the openings of the device according to the invention.

FIG. 5 is a schematic representation of an adjustment means of the 4-cover system type with 1 degree of freedom for the openings of the device according to the invention.

FIG. 6 is a schematic representation of an adjustment means of the 3-cover system type for the openings of the device according to the invention.

### DETAILED DESCRIPTION

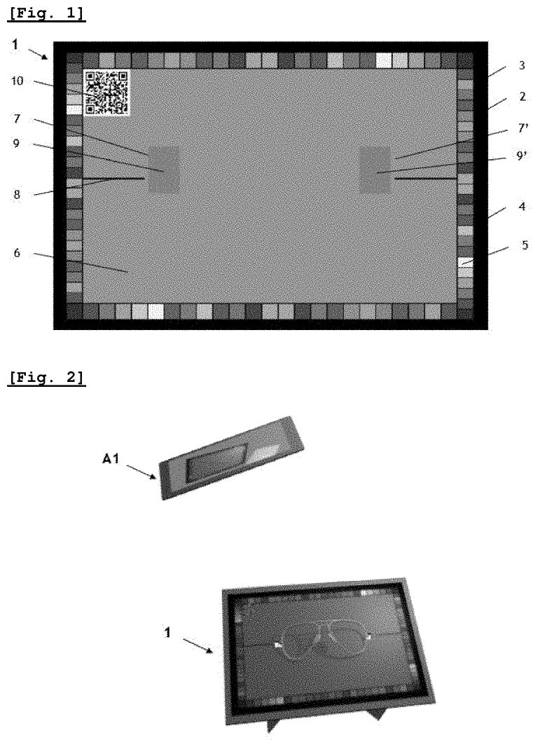

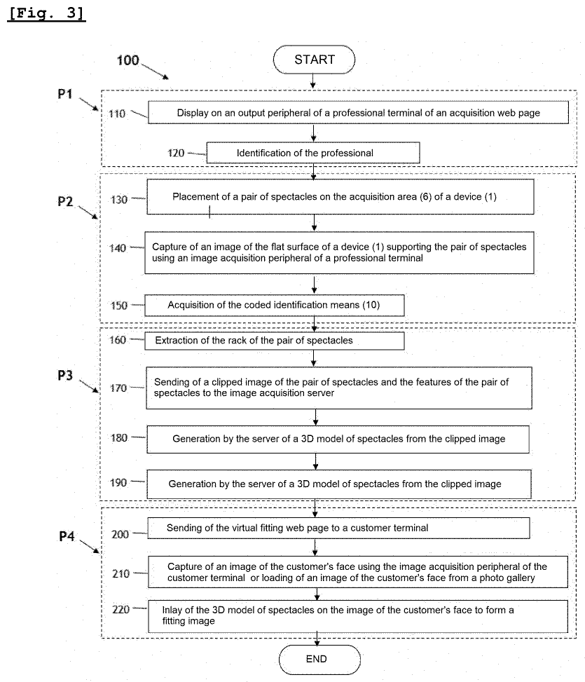

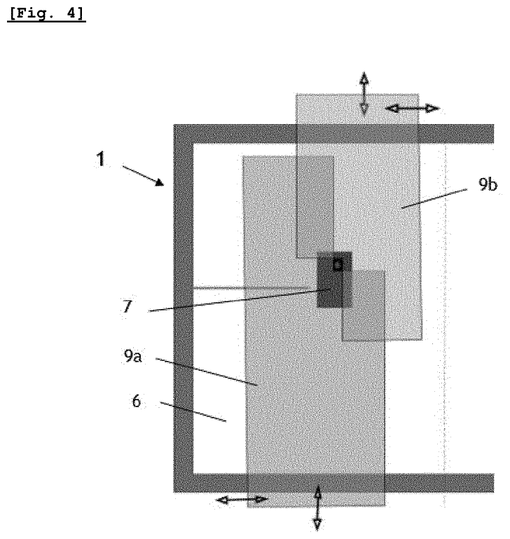

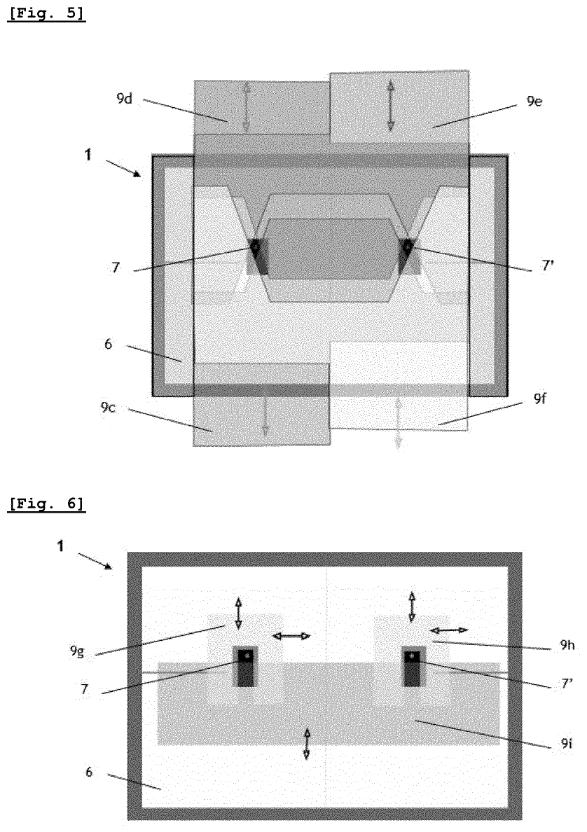

In accordance with FIGS. 1 to 6, provision is therefore made of a device 1 for acquiring images of a pair of spectacles comprising a flat surface defined by an outline 2 having a known shape and dimensions, said flat surface being remarkable in that it comprises at least, on the periphery thereof:
a straightening means 3,
a size reference 4, and

in the centre:
an acquisition area 6 having a homogenous, non-reflective colour, said acquisition area 6 comprising at least two openings 7, 7′ intended to support the legs of said pair, and at least one position marker 8 representing the pupils of a wearer, so as to facilitate the height positioning of the spectacle lenses in said acquisition area 6.

Regardless of the wearer, their pupils are at approximately the same height at the spectacle lens when the spectacles are worn. It is possible to materialise this height by a line called “line of sight”.

The colour of the acquisition area 6 is selected according to the colour of the pair of spectacles, the aim being that the colour of the pair of spectacles stands out as much as possible from the background colour of the acquisition area 6. Advantageously, the colour of the acquisition area 6 is an antireflection (matte) background colour. These choices in terms of the colour of the acquisition area 6 will facilitate the clipping. Preferably, the flat surface has an outline 2 of rectangular shape and has a colorimetric pattern 5.

This flat surface is preferably of A4 dimension to be easily transportable, it can be provided with feet 10 to 15 cm high, to allow it to be held in a horizontal position by reserving sufficient space for the legs of the pair of spectacles.

Advantageously, the straightening means 3 and the size reference 4 are a black frame marking said outline 2 of known dimensions. The fact that the black frame has known dimensions (length and width) makes it easy to straighten an image that has not been correctly taken from the front. Indeed, when the front image has not been taken correctly, the dimensions of the frame measured on the image are no longer the same. It is then possible to warp the image to obtain the frame with its initial dimensions. Several parameters of the image are thus corrected (orientation, perspective, . . . ) thus allowing to obtain a perfectly front view of the device 1. Several other means can be used for the purpose of straightening, in certain cases, the image acquisition apparatus can be installed on a specific support which will allow to adjust its positioning relative to the flat surface and to control the angle of view. Moreover, this black frame also plays a role of size 4 or scale reference, since the real dimensions thereof are known. Other size 4 references may be used (graduated ruler, checkerboard . . . ). Finally, this frame, by marking the outline 2 of the flat surface with its black colour, perfectly delimits the acquisition support 6 and facilitates the cropping of the image.

Preferably, the colorimetric pattern 5 is positioned between the black frame and the acquisition area 6. It is captured by an image acquisition apparatus and serves as reference to correct any colour deviations observed between the colour of the actual object and the colour of the object in the image. These colour deviations observed can be related in particular to the lighting during the photo capture.

Preferably, the openings 7, 7′ include adjustment means 9, 9a, 9b, 9c, 9d, 9e, 9f, 9g, 9h, 9i, of identical colour to that of the acquisition area 6, allowing said openings 7, 7′ to adapt to different types of spectacle legs. The different pairs of spectacles on the market have legs of different shapes and thicknesses that can be joined at the top of the rack, at ⅓-⅔ of the height of the rack or in the middle. To be able to support these different varieties of legs, the openings 7, 7′ are designed with a fairly large perimeter, around 30 by 30 mm for rectangular openings 7, 7′. The large size of these openings 7, 7′ can cause difficulties during the clipping step, which is why adjustment means 9, 9a, 9b, 9c, 9d, 9e, 9f, 9g, 9h, 9i, of identical colour to that of the acquisition surface 6 are used.

These adjustment means 9, 9a, 9b, 9c, 9d, 9e, 9f, 9g, 9h, 9i limit the openings 7, 7′ only to the space sufficient for the passage of the legs of the pair of spectacles. Even more preferentially, the adjustment means 9, 9a, 9b, 9c, 9d, 9e, 9f, 9g, 9h, 9i, include at least two U-shaped covers, 9g, 9h, the width of the opening of which may vary depending on the width of the legs of the spectacles and a cover 9i, in the shape of a rectangle and are intended to be disposed at the front of the openings 7, 7′ in order to limit their surfaces. The slots or openings of these covers 9g, 9h can have 3 different widths (4, 7 or 8 mm) so as to adapt to all racks on the market. The U-shaped covers 9g, 9h limit the height and width of the openings 7, 7′ by their morphologies, they have 2 degrees of freedom. The rectangular cover 9i, limits the height only and has 1 degree of freedom. Other adjustment means 9, 9a, 9b, 9c, 9d, 9e, 9f, 9g, 9h, 9i, having a colour identical to the acquisition area 6 can be considered, such as for example:
wefts of threads: two wefts of threads are superimposed perpendicularly (that is to say a frame oriented at 90° from the other),
loose materials: of the sand or gel type wherein the legs can sink,
fabric with buttonhole or star type slot,
cover system 9, 9a with 2 degrees of freedom: each opening 7, 7′ can be concealed by two covers 9, 9a, a first L-shaped 9a and a second L-shaped 9b turned over at 90° in the clockwise direction,
4-cover system 9b, 9c, 9d, 9e, 9f, with 1 degree of freedom: 2 covers in the shape of teeth 9c, 9d and 2 in the shape of ratchets 9e, 9f, the various covers 9b, 9c, 9d, 9e, 9f, of complementary shapes being positioned mirror-like and superimposed 2 by 2, the remaining opening will have a diamond shape.

Advantageously, the acquisition area 6 includes a coded identification means 10 allowing information concerning said device 1 to be obtained. This identification means can be a QR code for example. It allows to know the dimension of the device 1 for example.

The invention also relates to a method 100 for acquiring images of a pair of spectacles using a device 1 as described previously, remarkable in that it includes at least the following steps:

a) Phase of Identification P1 on a professional terminal A1:

a1) Display on an output peripheral of the professional terminal A1 of an acquisition web page 110,

a2) Identification of the professional 120,

b) Acquisition Phase P2:

b1) Placement of a pair of spectacles on the acquisition area 6 of a device 1, 130,

b2) Capture of an image of the flat surface of a device 1 supporting the pair of spectacles using an image acquisition peripheral of a professional terminal A1, 140,

b3) Acquisition of the coded identification means 10, 150,

c) Image processing phase P3,

c1) Extraction of the rack of the pair of spectacles 160,

c2) Sending of a clipped image of the pair of spectacles and the features of the pair of spectacles to a virtual fitting server 170,

c3) Generation by the server of a 3D model of spectacles from the clipped image 180,

c4) Generation of a virtual fitting web page by the professional terminal A1, 190,

d) Fitting phase P4:

d1) Sending of the virtual fitting web page to a customer terminal 200,

d2) Capture of an image of the customer's face using the image acquisition peripheral of the customer terminal or loading of an image of the customer's face from a photo gallery 210,

d3) Inlay of the 3D model of spectacles on the image of the customer's face to form a fitting image 220.

Preferably, there is between c1, 160, and c2,170, a step c1′:

Visual verification of the quality of the extraction. During this step, the professional checks the shot, the presence or not of parasitic reflections, the quality of the clipping . . . . It is also possible to display the pair of spectacles superimposed on a face and to manually modify the wedging of the rack (mainly in height), but also to manually retouch the colorimetry (saturation etc.)

Preferably, after step a2 120, there is a step a3: Search for the 3D model of the pair of spectacles in a catalogue present on the server, and:
if the pair of spectacles is not present in the catalogue: after step c3 180, there is a step c3′: Saving the 3D model of the pair of spectacles in the catalogue on the server,
if the pair of spectacles is present in the catalogue: the image acquisition P1 and processing P2 phases are not carried out and the fitting phase P4 is carried out from the 3D model of spectacles in the catalogue.

Professional A1 and customer terminals can be computers, tablets, or mobile phones. It is possible to consider that they are communicating by Internet.

Even more preferably, step c1 160 comprises the following sub-steps:

c11) Straightening of the image of the flat surface of the device (1) supporting the pair of spectacles 161,

c111) Detection of the straightening means 161a,

c112) Perspective correction 161b,

c113) Extraction of the area of the image containing the pair of spectacles 161c,

c12) Clipping of the rack of the pair of spectacles 162,

c121) Removal of the coloured background 162a,

c122) Normalisation of the resolution 162b.

The overall straightening process 161 is as follows: Detection of the black frame on the captured image, warping of the image to obtain black frame of dimensions identical to those of the black frame of the support, cropping at the black frame to have an image of known dimensions (image with dimensions of the frame), cropping of the area of interest (the metric size of the area of interest is fixed and dependent on the mesh used for the 3D model). The processing operations used for this step are as follows: Morphological filtering, adaptive thresholding, outline detection, selection of outlines on the basis of the constraints of the device 1, homography. For clipping 162, the overall process is as follows: from the image obtained in the previous step, extraction of the background and generation of a transparency plane, resizing of the image to obtain the final texture within the constraints on the resolution. The algorithm used for the extraction is based on a distance measurement in the HSV colour space. Depending on the distance, thresholding is applied with the management of an anti-aliasing ramp at the border. Other algorithms are potentially usable: Thresholding, Watershed, Flood Fill, Histogram back projection, Grab Cut, Outline Detection . . . .

Preferably, after step c12, 162, there is a step of automatic correction c13 allowing to correct errors related to step b2, 140, of capture (rack captured not horizontal . . . ). During this step, the clipped rack can undergo a slight rotation (so that the pair of spectacles is well positioned along a horizontal plane) or else a horizontal centring.

Advantageously, step c1, 160, is carried out by an artificial intelligence algorithm. For certain types of pairs of spectacles, pair of sunglasses or pairs of spectacles with invisible racks, the clipping step 160 can prove to be very difficult. It is therefore possible to imagine that this step 160 is carried out by an artificial intelligence algorithm trained on a catalogue of several models of pairs of spectacles. The algorithm will thus be more and more efficient. In this case, the clipping will be carried out by the server and not by the professional terminal A1.

The method 100 can also provide a step of extracting the spectacle lenses. This step, delimiting the area occupied by spectacle lenses on a pair, will aim at applying a warping at this area in order to simulate the effect that the spectacle lenses will have. Indeed, depending on the correction prescribed by the ophthalmologist, spectacle lenses cause warping the area on which they are placed. The rendering of the fitting will thus be even more realistic. The invention finally relates to a system for the acquisition of images remarkable in that it includes at least:
an image acquisition device 1 as described above,
a customer terminal communicating with a professional terminal A1, including at least one input and output peripheral allowing at least the implementation of the fitting phase P4 of the method 100 as described above,
a professional terminal A1 communicating with said customer terminal and a server, including at least one input and output peripheral allowing at least the implementation of the identification P1, acquisition P2 phases, the steps c1, c2 and c4, 160, 170, 180 of the image processing phase P3, of the method 100 as described previously,
a virtual fitting server communicating with the professional terminal A1, said server being designed to implement at least step c3 180 of the image processing phase P3 of the method 100 as described previously.

The professional A1 and customer terminals can be computers, tablets, or mobile phones. It is possible to consider that the communication between the various entities of the system is established by Internet.

The image acquisition method 100 is used with the image acquisition device 1 previously described. However, this method can be used with any type of support known to the person skilled in the art.

The device 1 for acquiring images of pairs of spectacles and the method 100 in accordance with the invention find a particular application in the virtual fitting of spectacles. However, it is obvious that the device 1 for acquiring images of pairs of spectacles and the method 100 can be adapted and used for the image acquisition of other types of equipment.

Finally, it goes without saying that the examples of device 1 for acquiring images of pairs of spectacles and the method 100 in accordance with the invention which have just been described are only particular illustrations, in no way limiting of the invention.

1-10. (canceled)

11. A device for acquiring images of a pair of spectacles, comprising: a flat surface defined by an outline having a known shape and dimensions, said flat surface comprises at least, on the periphery thereof: a black frame marking said outline having known dimensions,
and in the centre:
an acquisition area having a homogenous, non-reflective colour, said acquisition area comprising at least two openings intended to support the legs of said pair, and at least one position marker representing the pupils of a wearer, so as to facilitate the height positioning of the spectacle lenses in said acquisition area.

12. The device according to claim 11, wherein the flat surface has an outline of rectangular shape and has a colorimetric pattern.

13. The device according to claim 12, wherein the colorimetric pattern is positioned between the black frame and the acquisition area.

14. The device according to claim 11, wherein the openings include adjustment means of identical colour to that of the acquisition area allowing said openings to adapt to different types of spectacle legs.

15. The device according to claim 14, wherein the adjustment means include at least two U-shaped covers, the width of the opening of which may vary depending on the width of the legs of the spectacles, a cover in the shape of a rectangle and in that they are intended to be disposed at the front of the openings in order to limit their surfaces.

16. A method for acquiring images of a pair of spectacles using the device according to claim 11, comprising least the following steps:
a) a phase of Identification on a professional terminal:
a1) display on an output peripheral of the professional terminal of an acquisition web page,
a2) identification of the professional,
b) an acquisition Phase:
b1) placement of a pair of spectacles on the acquisition area of the device,
b2) capture of an image of the flat surface of the device supporting the pair of spectacles using an image acquisition peripheral of a professional terminal,
b3) acquisition of the coded identification means,
c) an image processing phase,
c1) extraction of the rack of the pair of spectacles,
c2) sending of a clipped image of the pair of spectacles and the features of the pair of spectacles to an image acquisition server,
c3) generation by the server of a 3D model of spectacles from the clipped image,
c4) generation of a virtual fitting web page by the professional terminal,
d) a fitting phase:
d1) sending of the virtual fitting web page to a customer terminal,
d2) capture of an image of the customer's face using the image acquisition peripheral of the customer terminal or loading of an image of the customer's face from a photo gallery,
d3) inlay of the 3D model of spectacles on the image of the customer's face to form a fitting image.

17. The method according to claim 16, wherein after step a2, there is a step a3: search for the 3D model of the pair of spectacles in a catalogue present on the server, and in that:
if the pair of spectacles is not present in the catalogue: after step c3, there is a step c3′: saving the 3D model of the pair of spectacles in the catalogue on the server,
if the pair of spectacles is present in the catalogue: the image acquisition and processing phases are not carried out and the fitting phase is carried out from the 3D model of spectacles in the catalogue.
